(19) United States
(12) Patent Application Publication
(10) Pub. No.: US 2014/0020003 A1
(43) Pub. Date: Jan. 16, 2014

(54) DYNAMIC BANDWIDTH REDUCTION OF TRANSMISSION STREAMS

(71) Applicants: SHAREEF F. ALSHINNAWI, DURHAM, NC (US); GARY D. CUDAK, CREEDMOOR, NC (US); EDWARD S. SUFFERN, CHAPEL HILL, NC (US); J. MARK WEBER, WAKE FOREST, NC (US)

(72) Inventors: SHAREEF F. ALSHINNAWI, DURHAM, NC (US); GARY D. CUDAK, CREEDMOOR, NC (US); EDWARD S. SUFFERN, CHAPEL HILL, NC (US); J. MARK WEBER, WAKE FOREST, NC (US)

(73) Assignee: INTERNATIONAL BUSINESS MACHINES CORPORATION, ARMONK, NY (US)

(21) Appl. No.: 13/545,391

(22) Filed: Jul. 10, 2012

(51) Int. Cl. H04N 21/24; G06F 15/16

(52) U.S. Cl. 725/12; 709/224

(57) ABSTRACT

A processor implemented method conserves bandwidth capacity by reducing the amount of bandwidth that is used in a communication channel between a content transmitting server and a content receiving client computer while streaming multimedia content. A content receiving client computer receives a multimedia streaming content from a content transmitting server. The multimedia streaming content has a video component and an audio component. In response to determining that a user of the content receiving client computer is no longer watching the video component of the multimedia streaming content, a processor generates and transmits an inattention alert to the content transmitting server. The inattention alert directs the content transmitting server to stream only the audio component of a remaining portion of the multimedia streaming content to the content receiving client computer.

### BACKGROUND

The present disclosure relates to the field of computing hardware, and specifically to computer hardware used in transmitting audio and video streams. Still more specifically, the present disclosure relates to conserving bandwidth during audio and/or video streaming.

Streaming media is combined audio and video content that is delivered to an end user by a streaming provider. That is, streaming media is delivered in a manner that allows a user to start viewing the content before all of the content is delivered. An analogy can be drawn to drinking from a lake as opposed to drinking from a stream. Drinking from a lake is analogous to downloading a complete set of data, such as a book, album of music, etc., which cannot be used until the entire download is complete. Drinking from a stream is analogous to viewing a buffering video, such as a video clip, such that the user can view an initial portion of the video clip while a subsequent portion is loading into a local buffer. Thus, the second scenario is known as “streaming”.

### SUMMARY

In one embodiment, a processor implemented method conserves bandwidth capacity by reducing the amount of bandwidth that is used in a communication channel between a content transmitting server and a content receiving client computer while streaming content. A content receiving client computer receives a multimedia streaming content from a content transmitting server. The multimedia streaming content has a video component and an audio component. In response to determining that a user of the content receiving client computer is no longer watching the video component of the multimedia streaming content, a processor generates and transmits an inattention alert to the content transmitting server. The inattention alert directs the content transmitting server to stream only the audio component of a remaining portion of the multimedia streaming content to the content receiving client computer.

In one embodiment, a content transmitting server comprises a server link interface coupled to a communication link, where the communication link is communicatively coupled to a content receiving client computer. A multimedia content buffer in the content transmitting server holds a multimedia content that has a video component and an audio component. A multimedia-to-audio-only (MTAO) converter in the content transmitting server converts the multimedia content into an audio-only content in response to receiving an inattention alert from the content receiving client computer. This inattention alert is generated in response to a viewer attention detector at the content receiving client computer determining that a user of the content receiving client computer is not watching the video component of the multimedia content. Thus, only the audio-only content is transmitted from the content transmitting server to the content receiving client computer, thereby saving bandwidth in the communication link.

In one embodiment, a content receiving client computer comprises a client link interface coupled to a communication link, where the communication link is communicatively coupled to a content transmitting server. The content receiving client computer also comprises a viewer attention detector and an inattention alert generator. The inattention alert generator generates an inattention alert for transmission to the content transmitting server in response to detecting that a user of the content receiving client computer is not watching a multimedia streaming content that is being streamed from the content transmitting server to a video display on the content receiving client computer.

The above as well as additional objectives, features, and advantages of the present invention will become apparent in the following detailed written description.

### BRIEF DESCRIPTION OF THE SEVERAL VIEWS OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts an exemplary physical computer in which the present invention may be implemented and/or utilized;

FIG. 2 illustrates an exemplary system having a content transmitting server and a content receiving client computer in accordance with one embodiment of the present invention; and

FIG. 3 is a high-level flow chart of one or more exemplary steps performed by hardware to reduce the amount of bandwidth used in a streaming content communication link between a content transmitting server and a content receiving client computer.

### DETAILED DESCRIPTION

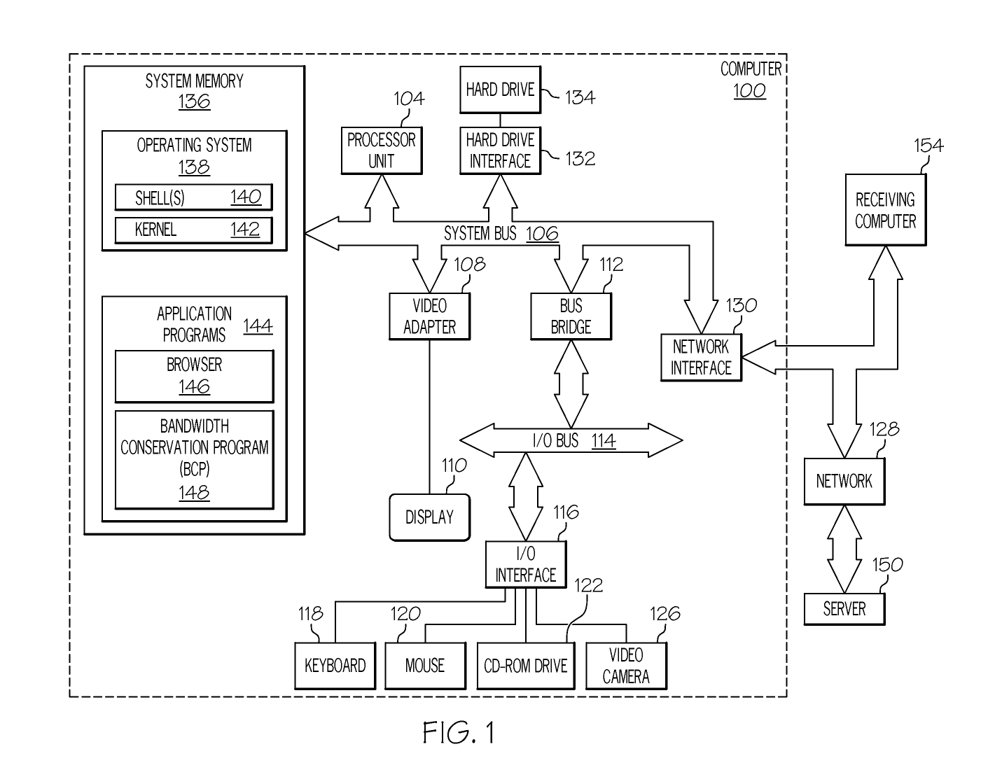

With reference now to FIG. 1, there is depicted a block diagram of an exemplary computer 100, with which and/or in which the present invention may be utilized. Computer 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, and a video camera 126. The format of the ports connected to I/O interface 116 may be any known to those skilled in the art of computer architecture, including but not limited to Universal Serial Bus (USB) ports.

Computer 100 is able to communicate with a server 150 and/or receiving computer 154 via a network 128 using a network interface 130, which is coupled to system bus 106. Network 128 may be an external network such as the Internet, or an internal network such as an Ethernet or a Virtual Private Network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 (as it is called in UNIX®—UNIX is a registered trademark of The Open Group in the United States and other countries), also called a command processor in Windows® (WINDOWS is a registered trademark of Microsoft Corporation in the United States and other countries), is a program that provides an interpreter and an interface between the user and the operating system, and is generally the highest level of the operating system software hierarchy and serves as a command interpreter. Thus, shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management.

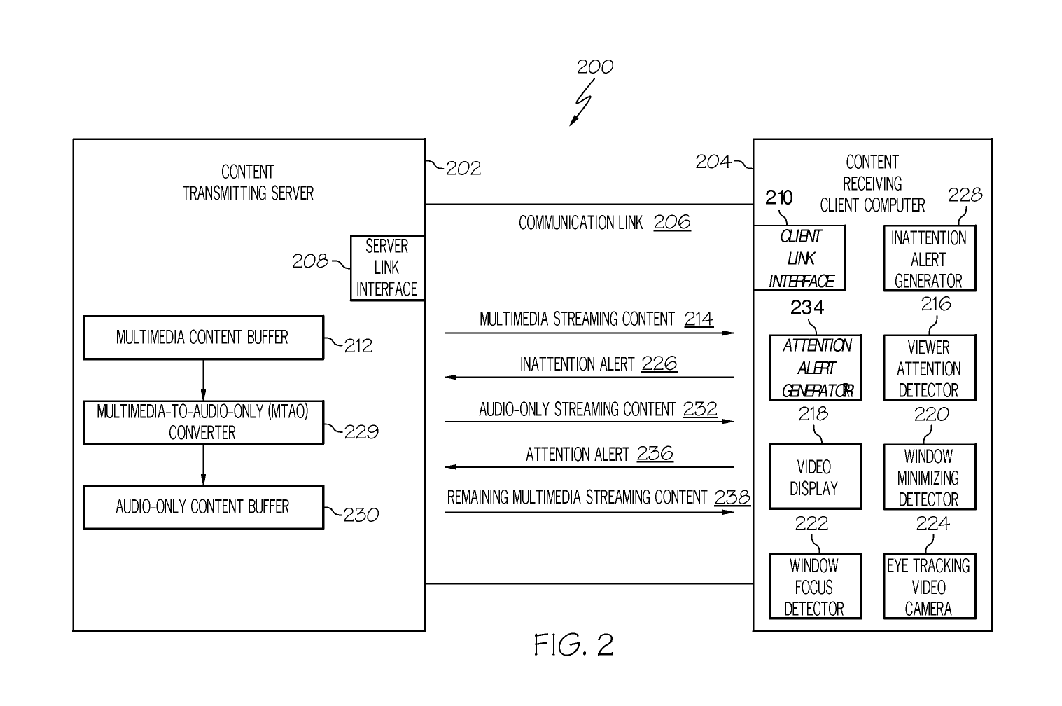

Application programs 144 include a browser 146. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150. Application programs 144 in system memory 136 also include a bandwidth conservation program (BCP) 148, which, in one embodiment, executes the process described below in FIG. 2. In one embodiment, computer 100 is able to download BCP 148 from service provider server 150, preferably in an “on demand” basis.

The hardware elements depicted in computer 100 are not intended to be exhaustive, but rather are representative to highlight essential components required by the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention. Note that the hardware architecture for service provider server 150 and/or receiving computer 154 may be substantially similar to that shown for computer 100.

Referring now to FIG. 2, an exemplary system having a content transmitting server 202 (analogous to computer 100 shown in FIG. 1) and a content receiving client computer 204 (analogous to receiving computer 154 shown in FIG. 1) in accordance with one embodiment of the present invention is presented. Content transmitting server 202 is communicatively coupled to content receiving client computer 202 by a communications link 206 (analogous to network 128 shown in FIG. 1), which may be a network line, a data transmission line, a metal or fiber optics line, or any other communication line that has a finite amount of bandwidth capacity (e.g., has a finite bits/second rate of transmission capacity). The content transmitting server 202 is coupled to the communication link 206 by a server link interface 208, while the content receiving client computer 204 is coupled to the communication link 206 by a client link interface 210. Within content transmitting server 202 is a multimedia content buffer 212, which holds multimedia streaming content 214. This multimedia streaming content 214 (e.g., a movie, animation, etc.) has a video component (i.e., the visual aspect of the multimedia content) and an audio component (i.e., the aural aspect of the multimedia content). In one embodiment, the video component and the audio component are integrated into a single unit. For example, assume that the multimedia streaming content 214 is a 2 hour movie that has been digitized into a series of segments, and that the series of segments correspond to a series of multimedia data packets, such that each segment in the series of segments is embodied in its own discrete multimedia data packet for streaming. As such, each discrete data packet includes digital data required to render both the video portion as well as an audio portion of a particular segment of the movie.

Thus, multimedia streaming content 214 from the multimedia content buffer 212 is initially streamed (i.e., as a series of multimedia data packets) with both the video component and the audio component of the multimedia content. However, at some point during the streaming of the multimedia streaming content 214, a viewer attention detector 216 in content receiving client computer 204 will detect that a client user is no longer watching a video display 218 (analogous to display 110 shown in FIG. 1). For example, a window minimizing detector 220 may detect that a window, on which the multimedia streaming content 214 was being displayed on the video display 218, has been minimized. Thus, the viewer attention detector 216 is able to determine that the user cannot be watching the multimedia streaming content 214 on the video display 218. Similarly, a window focus detector 222 may determine that the window, on which the multimedia streaming content 214 was being displayed on the video display 218, has lost its focus (i.e., this first window has been moved behind a second window on the video display), such that the second window obscures the first window and the user cannot be watching the multimedia streaming content 214 on the video display 218.

In one embodiment, the viewer attention detector 216 may determine that the user/viewer is no longer watching the multimedia streaming content 214 being presented on the video display 218 if a user is no longer watching the video display 218, and more specifically the multimedia streaming content 214. In this embodiment, an eye tracking video camera 224, which is logically coupled to the viewer attention detector 216, tracks the user's eye movement. Eye tracking video camera 224 is an intelligence-enhanced version of the video camera 126 depicted in FIG. 1, and in one embodiment, is attached to a video display 218. By knowing where on the video display 218 the multimedia streaming content 214 is being displayed (e.g., at the top of the display, the bottom of the display, etc.), and by receiving outputs from the eye tracking video camera 224 that track where the user is looking, the viewer attention detector 216 determines whether or not the user is still watching the video component of the multimedia streaming content 214. In one embodiment, if the user has not been watching the video component of the multimedia streaming content 214 for more than a predetermined length of time (e.g., for more than five minutes), then an inattention alert 226 is generated.

Inattention alert 226 is generated by an inattention alert generator 228 in the content receiving computer 204. The inattention alert generator 228 generates the inattention alert 226 in response to the window on which the multimedia streaming content 214 was being displayed on the video display 218 being minimized (using the window minimizing detector 220 in a manner described above); in response to the window on which the multimedia streaming content 214 was being displayed on the video display 218 being moved behind another window (using the window focus detector 222 in a manner described above); or in response to the user failing to watch the window on which the multimedia streaming content 214 is being displayed on the video display 218 for longer than some predetermined length of time (using the eye tracking video camera 224 in a manner described above).

In one embodiment, the inattention alert 226 simply notifies the content transmitting server 202 that the user of the content receiving client computer 204 is no longer watching the video component of the multimedia streaming content 214. In another embodiment, the inattention alert 226 directs the content transmitting server 202 to stream only the audio component of a remaining portion of the multimedia streaming content 214 to the content receiving client computer 204. In order to accomplish this task, the content transmitting server 202 first determines what portions of the multimedia streaming content 214 remain to be streamed. This can be accomplished in various ways. For example, if the entire multimedia content remains stored in the multimedia content buffer 212, then a pointer/flag can track which segments/packets of the multimedia content have already been streamed, thus identifying those segments/packets that have not yet been streamed. In another embodiment, the multimedia content buffer 212 can be a pop-off buffer (e.g., a first-in-first-out FIFO buffer), such that any segment/packet that has been popped off has already been streamed, leaving only the segments/packets that have yet to be streamed. In either embodiment, a copy of the remaining segments/packets (which have not been streamed to the content receiving client computer 204) are converted by a multimedia-to-audio-only (MTAO) converter 229, which pushes the audio-only component of the multimedia streaming content 214 into an audio-only content buffer 230.

Note that a copy of the remaining segments/packets in the multimedia content buffer 212, and not the remaining segments/packets themselves, are converted by the MTAO converter 229. This leaves a full version (video and audio) of the multimedia content in the multimedia content buffer 212 for future use (see below). In one embodiment, when the audio-only packet that corresponds to a particular full version packet (video and audio) is streamed to the content receiving client computer 204, then the corresponding full version packet is popped off the multimedia content buffer 212, thus freeing up space in the multimedia content buffer 212. However, as noted above, the multimedia content buffer 212 can be architected to keep a complete copy of the multimedia content. In this case, the full version of the multimedia content is kept in the multimedia content buffer 212, regardless of what has been streamed and what (if anything) has been converted into an audio-only format.

As the MTAO converter 229 converts segments of the full version (video and audio) of the multimedia content into audio-only packets, these audio-only packets are streamed to the content receiving client computer 204 as audio-only streaming content 232. Thus, rather than having to carry the larger packets found in the full-version multimedia streaming content 214, communication link 206 now only has to carry the much smaller packets that make up the audio-only streaming content 232, thus reducing the bandwidth consumption (i.e., conserves the bandwidth streaming capacity of the connection) of the communication channel that is communication link 206. Note that in the present invention, the term “bandwidth” is defined as the number of bits that are conveyed per unit of time (e.g., 10 megabits per second) over a communication line. Thus, “bandwidth capacity” is the amount of bandwidth that the communication line can convey, and “bandwidth conservation” is the process of reducing how much of the bandwidth capacity is used. Thus, “bandwidth reduction” is a reduction in the amount of bandwidth (bits conveyed per unit of time) from the bandwidth capacity that is actually used during transmission of transmission streams. For example, and within the context of the present invention, transmitting audio-only content instead of audio and video multimedia content results in a bandwidth reduction, since the audio-only content requires less bandwidth.

As some point, however, the content receiving client computer 204 may determine that the user once again wants to watch the video component of the multimedia content. This determination is not made directly by the user, (i.e., the user does not enter an instruction to resume transmission of the video component), but rather is made by logic within the content receiving client computer 204.

For example, in one embodiment, assume that the window minimizing detector 220 detects that the original streaming content window, on which the multimedia streaming content 214 was initially displayed, is once again maximized on the video display 218. In this embodiment, an attention alert generator 234 generates and transmits an attention alert 236 to the content transmitting server 202.

In one embodiment, assume that the window focus detector 222 detects that the original streaming content window, on which the multimedia streaming content 214 was initially displayed, has once again regained focus (i.e., has once again been moved in front of another window being displayed on the video display 218). As in the embodiment above, the attention alert generator 234 generates and transmits an attention alert 236 to the content transmitting server 202.

In one embodiment, assume that the window minimizing detector 220, along with the eye tracking video camera 224, determines that the user is once again looking at the video display 218 (e.g., for some predetermined length of time). As in the embodiment above, the attention alert generator 234 generates and transmits an attention alert 236 to the content transmitting server 202.

In any of the embodiments described above, the attention alert 236 directs the content transmitting server 202 to stop streaming the audio-only streaming content 232, and to resume transmitting the remaining portion of the multimedia streaming content (containing both the video component and the audio component), depicted as remaining multimedia streaming content 238, to the content receiving client computer 204. Again, if the multimedia content buffer 212 is a pop-off buffer that pops off segments/packets as they are being converted by the MTAO converter 229, then the remaining multimedia streaming content 238 is simply whatever remains in the multimedia content buffer 212. However, if the multimedia content buffer 212 keeps a complete copy of the multimedia content, then a flag/pointer must be used to determine what full version multimedia content needs remains to be streamed.

Note that in one embodiment, the viewer attention detector 216, the window minimizing detector 220, the window focus detector 222, the inattention alert generator 228, the MTAO converter 229, and/or the attention alert generator 234 may be software components of BCP 148 shown in FIG. 1. In one embodiment, the viewer attention detector 216, the window minimizing detector 220, the window focus detector 222, the inattention alert generator 228, the MTAO converter 229, and/or the attention alert generator 234 may be hardware components, such as field programmable gate arrays (FPGAs), that are specially architected to perform the functions described above.

As described herein, the inattention alert generator 228, the attention alert generator 234, and the various supporting components described in FIG. 2, collectively are a client stream visibility notification system (CSVNS). The inattention alert 226 and the components that generated it are a stream interrupt notification system (SINS). The communication link 206, server link interface 208, and client link interface 210 collectively are a stream transfer system (STS). The multimedia content buffer 212, MTAO converter 229, audio-only content buffer 230, and supporting processor logic (i.e., processor unit 104 shown in FIG. 1) are a server stream coordination mechanism (SSCM). Just the multimedia content buffer 212, MTAO converter 229, audio-only content buffer 230 make up a stream conversion system (SCS). The audio-only streaming content 232 is a temporary audio stream (TAS).

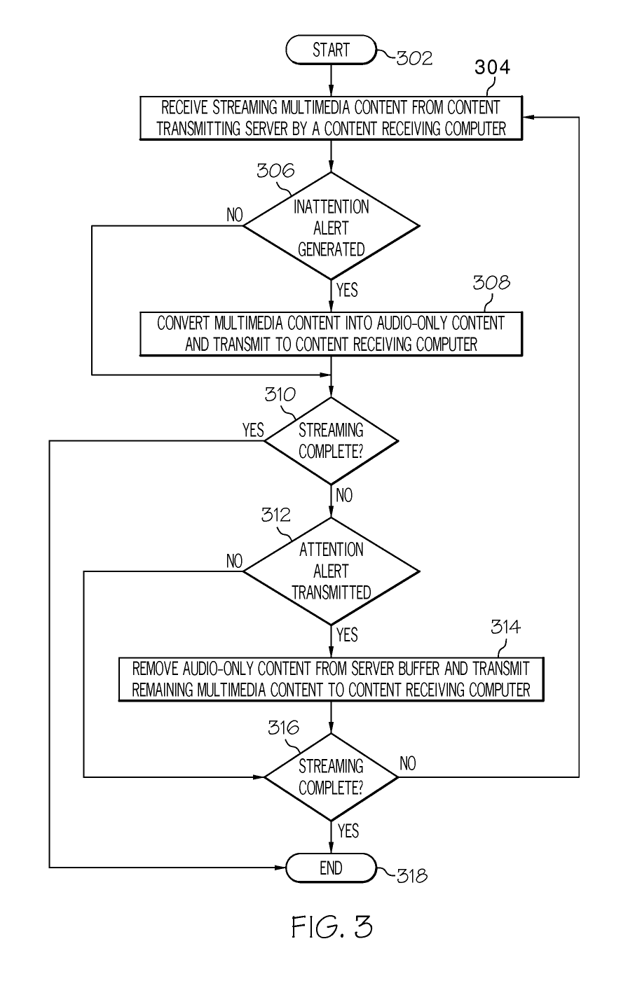

With reference now to FIG. 3, a high-level flow chart of one or more exemplary steps performed by hardware to conserve bandwidth capacity in a streaming content communication link between a content transmitting server and a content receiving client computer is presented. After initiator block 302, streaming multimedia content is received from a content transmitting server by a content receiving computer, where the streaming multimedia content is displayed (block 304).

As indicated by query block 306, a determination is made as to whether or not the user is still watching the video component of the multimedia streaming content. If not, a processor generates and transmits an inattention alert to the content transmitting server. This causes the content transmitting server to convert the multimedia content into audio-only content, such that only the audio component of a remaining portion of the multimedia streaming content is streamed to the content receiving client computer (block 308). If all of the streaming content (i.e., the now converted audio portion) is complete (query block 310), then the process ends at terminator block 318. However, if there is still more content to be streamed, then a determination is made as to whether the content receiving client computer has generated an attention alert (query block 312), which causes the audio-only content to be removed from the audio-only server buffer in the content transmitting server, such that the full version (video and audio) of the remaining portion of the multimedia streaming content is streamed to the content receiving computer (block 314). If the streaming of the full version is complete (query block 316), then the process ends (terminator block 318). If not (query block 316), then the content transmitting server continues to monitor the communication link for another inattention alert from the content receiving client computer (blocks 304 and 306).

Thus, in one embodiment, a processor implemented method conserves bandwidth (i.e., reduces the consumption of bandwidth) in a communication channel between a content transmitting server and a content receiving client computer while streaming multimedia content. A content receiving client computer receives a multimedia streaming content from a content transmitting server, wherein the multimedia streaming content has a video component and an audio component. The multimedia streaming content is displayed on a video display at the content receiving client computer. In response to determining that a user of the content receiving client computer is no longer watching the video component of the multimedia streaming content, a processor generates and transmits an inattention alert to the content transmitting server. This inattention alert directs the content transmitting server to stream only the audio component of a remaining portion of the multimedia streaming content to the content receiving client computer.

In one embodiment, the processor implemented method further comprises determining that the user is no longer watching the video component by detecting that the user has minimized a streaming content window on which the multimedia streaming content was being displayed on the video display.

In one embodiment, the processor implemented method further comprises, in response to determining that the user is once again watching the streaming content window, transmitting an attention alert from the content receiving client computer to the content transmitting server, wherein the attention alert directs the content transmitting server to transmit a remaining portion of the multimedia streaming content with both the video component and the audio component to the content receiving client computer, and wherein the user is determined to once again be watching the streaming content window in response to the streaming content window being maximized on the video display.

In one embodiment, the processor implemented method further comprises tracking a user's eye movement with an eye tracking video camera; and determining that the user is no longer watching the video component in response to the viewer attention detector determining, from the user's eye movement, that the user has not watched the video display for more than a predetermined length of time.

In one embodiment, the processor implemented method further comprises, in response to the eye tracking video camera determining that the user is once again watching a video display, transmitting an attention alert to the content transmitting server, wherein the attention alert directs the content transmitting server to transmit a remaining portion of the multimedia streaming content to the content receiving client computer.

In one embodiment, the processor implemented method further comprises determining that the user is no longer watching the video component by detecting that the user has moved a first window, on which the multimedia streaming content is being displayed on the video display, behind a second window on the video display.

In one embodiment, the processor implemented method further comprises, in response to the user moving the first window back in front of the second window, generating and transmitting an attention alert to the content transmitting server, wherein the attention alert directs the content transmitting server to transmit a remaining portion of the multimedia streaming content to the content receiving client computer.

Note further that the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A processor implemented method of conserving bandwidth capacity in a communication channel between a content transmitting server and a content receiving client computer while streaming multimedia content, the computer implemented method comprising:
receiving, by a content receiving client computer, a multimedia streaming content from a content transmitting server, wherein the multimedia streaming content has a video component and an audio component;
displaying the multimedia streaming content on a video display; and
in response to determining that a user of the content receiving client computer is no longer watching the video component of the multimedia streaming content, a processor generating and transmitting an inattention alert to the content transmitting server, wherein the inattention alert directs the content transmitting server to stream only the audio component of a remaining portion of the multimedia streaming content to the content receiving client computer.

2. The processor implemented method of claim 1, further comprising:
determining that the user is no longer watching the video component by detecting that the user has minimized a streaming content window on which the multimedia streaming content was being displayed on the video display.

3. The processor implemented method of claim 2, further comprising:
in response to determining that the user is once again watching the streaming content window, transmitting an attention alert from the content receiving client computer to the content transmitting server, wherein the attention alert directs the content transmitting server to transmit a further remaining portion of the multimedia streaming content with both the video component and the audio component to the content receiving client computer, and wherein the user is determined to once again be watching the streaming content window in response to the streaming content window being maximized on the video display.

4. The processor implemented method of claim 1, further comprising:
tracking a user's eye movement with an eye tracking video camera; and
determining that the user is no longer watching the video component in response to the eye tracking video camera and a viewer attention detector determining, from the user's eye movement, that the user has not watched the video display for more than a predetermined length of time.

5. The processor implemented method of claim 4, further comprising:
in response to the eye tracking video camera determining that the user is once again watching a video display, transmitting an attention alert to the content transmitting server, wherein the attention alert directs the content transmitting server to transmit a further remaining portion of the multimedia streaming content with both the video component and the audio component to the content receiving client computer.

6. The processor implemented method of claim 1, further comprising:
determining that the user is no longer watching the video component by detecting that the user has moved a first window, on which the multimedia streaming content is being displayed on the video display, behind a second window on the video display.

7. The processor implemented method of claim 6, further comprising:
in response to the user moving the first window back in front of the second window, generating and transmitting an attention alert to the content transmitting server, wherein the attention alert directs the content transmitting server to transmit a further remaining portion of the multimedia streaming content with both the video component and the audio component to the content receiving client computer.

8. A content transmitting server comprising:
a server link interface coupled to a communication link, wherein the communication link is communicatively coupled to a content receiving client computer;
a multimedia content buffer, wherein the multimedia content buffer holds a multimedia content that has a video component and an audio component; and
a multimedia-to-audio-only (MTAO) converter, wherein the MTAO converter converts the multimedia content into an audio-only content in response to receiving an inattention alert from the content receiving client computer, wherein the inattention alert is generated in response to a viewer attention detector at the content receiving client computer determining that a user of the content receiving client computer is not watching the video component of the multimedia content, and wherein only the audio-only content is transmitted from the content transmitting server to the content receiving client computer.

9. The content transmitting server of claim 8, further comprising:
an audio-only content buffer for buffering the audio-only content.

10. A content receiving client computer comprising:
a client link interface coupled to a communication link, wherein the communication link is communicatively coupled to a content transmitting server;
a viewer attention detector; and
an inattention alert generator, wherein the inattention alert generator generates an inattention alert for transmission to the content transmitting server in response to detecting that a user of the content receiving client computer is not watching a multimedia streaming content that is being streamed from the content transmitting server to a video display on the content receiving client computer, wherein the multimedia streaming content includes an audio component and a video component.

11. The content receiving client computer of claim 10, wherein the inattention alert directs the content transmitting server to transmit only the audio component from the multimedia streaming content.

12. The content receiving client computer of claim 10, further comprising:
a window minimizing detector, wherein the window minimizing detector determines that the user is no longer watching the video component by detecting that the user has minimized a streaming content window on which the multimedia streaming content is being displayed on the video display.

13. The content receiving client computer of claim 12, further comprising:
an attention alert generator, wherein the attention alert generator generates and transmits an attention alert to the content transmitting server in response to determining that the user is once again watching the streaming content window, wherein the user is determined to once again be watching the streaming content window in response to the streaming content window being maximized on the video display, and wherein the attention alert directs the content transmitting server to transmit a remaining portion of the multimedia streaming content with both the video component and the audio component to the content receiving client computer.

14. The content receiving client computer of claim 10, further comprising:
an eye tracking video camera for tracking a user's eye movement, wherein the eye tracking video camera is logically coupled to the viewer attention detector, and wherein the viewer attention detector determines that the user is no longer watching the video component in response to the viewer attention detector determining, from the user's eye movement tracked by the eye tracking video camera, that the user has not watched the video display for more than a predetermined length of time.

15. The content receiving client computer of claim 14, further comprising:
an attention alert generator, wherein the attention alert generator, in response to the viewer attention detector determining that the user is once again watching the video display, transmitting an attention alert to the content transmitting server, wherein the attention alert directs the content transmitting server to transmit a remaining portion of the multimedia streaming content with both the video component and the audio component to the content receiving client computer.

16. The content receiving client computer of claim 10, further comprising:
a window focus detector, wherein the window minimizing detector determines that the user is no longer watching the video component by detecting that the user has moved a first window, on which the multimedia streaming content is being displayed on the video display, behind a second window on the video display.

17. The content receiving client computer of claim 16, further comprising:
an attention alert generator, wherein the attention alert generator, in response to the user moving the first window back in front of the second window, generates and transmits an attention alert to the content transmitting server, wherein the attention alert directs the content transmitting server to transmit a remaining portion of the multimedia streaming content with both the video component and the audio component to the content receiving client computer.
